(19) United States
(12) Patent Application Publication
(10) Pub. No.: US 2019/0370887 A1
(43) Pub. Date: Dec. 5, 2019

(54) SYSTEM AND METHOD FOR IDENTIFYING OUTLETS BASED ON GEOGRAPHICAL LOCATION

(71) Applicant: WEASEL PRODUCTIONS (PTY) LTD, Brackenfell (ZA)

(72) Inventors: Marthinus Philippus Pretorius, Durbanville (ZA); Koert Hendrik Stefanus Pretorius, Durbanville (ZA); André Le Roux, Cape Town (ZA)

(21) Appl. No.: 15/995,754

(22) Filed: Jun. 1, 2018

(51) Int. Cl. G06Q 30/06; H04W 4/021; H04W 4/02; G06Q 10/08

(52) U.S. Cl. CPC G06Q 30/0639; G06Q 10/087; H04W 4/023; H04W 4/021

(57) ABSTRACT

A system and method for remotely ordering and dispensing items for collection are provided. A method at a server computer includes receiving a location data message from a consumer device. The message includes a destination geographical location towards which a consumer associated with the consumer device is destined to travel. A merchant outlet physically located at a geographical location related to the destination geographical location is identified. A selection of an item purveyed by the identified merchant outlet is received from the consumer device. An order request message is transmitted to a merchant device associated with the merchant outlet. The message includes an indication of the selected item and orders the selected item from the merchant outlet for collection by the consumer.

### FIELD OF THE INVENTION

This invention relates to a system and method for identifying outlets based on geographical location, particularly, but not exclusively, in the context of ordering items for collection.

### BACKGROUND TO THE INVENTION

In e-commerce related transactions in which a consumer purchases goods from a merchant remotely, merchants are increasingly using storage compartments, or “secured storage boxes”, for the transfer or dispensing of goods to the relevant consumer. Such storage compartments may obviate the otherwise potentially significant cost associated with so-called ‘last mile’ deliveries, where a delivery man is required to travel directly to the consumer in order to hand over the goods.

It may be desirable to extend the use of such storage boxes to the fast-food industry to allow consumers to order items from a merchant remotely. The merchant can then place the items in the box when ready and notify the consumer accordingly.

The use of such boxes in the fast-food industry may provide advantages in that queues may be shortened, as the number of consumers physically present at the merchant ordering and waiting for food may be reduced. This could, in turn, reduce the amount of floor space that the merchant is required to rent, as fewer consumers will need to be accommodated at any given time.

Typical remote ordering systems known in the art provide a prospecting consumer with a number of merchants located within a predetermined range of the consumer's current geographical location. The consumer may then select from these merchants one to his or her liking and proceed to order one or more items for collection.

While this may seem convenient, such systems may not adequately take into account other factors and may end up inconveniencing the consumer, to some extent. There is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention, there is provided a computer-implemented method conducted at a server computer and comprising: receiving, from a consumer device, a location data message including a destination geographical location towards which a consumer associated with the consumer device is destined to travel; identifying a merchant outlet physically located at a geographical location related to the destination geographical location; receiving, from the consumer device, a selection of an item purveyed by the identified merchant outlet; and, generating and transmitting, to a merchant device associated with the merchant outlet, an order request message including an indication of the selected item, the order request message ordering the selected item from the merchant outlet for collection by the consumer.

Further features provide for the method to include providing, to the consumer device, a list of items purveyed by the identified merchant outlet, and for the item selection to be a selection from the list of items.

Still further features provide for the location data message to include a current geographical location of the consumer device, for identifying the merchant outlet to include identifying a merchant outlet physically located at a geographical location related to the destination geographical location and the current geographical location, and for identifying the merchant outlet to include identifying a merchant outlet physically located at a geographical location falling within a predetermined range of a route between the current geographical location and destination geographical location.

Yet further features provide for the item selection to be associated with an amount and for the method to include processing a payment in respect of the amount against a financial account associated with the consumer in favor of a financial account associated with the merchant outlet. The financial account may be a credit/debit bank card account, wallet service account or the like.

A further feature provides for the method to include receiving, from the merchant device, a confirmation message confirming receipt of the order request message.

Further features provide for the method to include receiving an expected time of arrival indication indicating an expected time of arrival of the consumer at the merchant outlet; for the expected time of arrival to have been determined based on one or both of the current geographical location of the consumer device and the destination geographical location; alternatively for the expected time of arrival to have been input into the consumer device by the consumer; for the method to include obtaining a grace period associated with the expected time of arrival and by way of which early arrival or late arrival by the consumer for collection of the item is taken into account.

Still further features provide for the method to include maintaining merchant records relating to each merchant outlet, each merchant record including a geographical location and an operating status associated with the merchant outlet, for the merchant records to be stored in a database and to be updatable remotely by merchants; and for the method to include: receiving, from the merchant device, a status indication message indicating a change in the operating status of the merchant outlet; and, updating the merchant record to reflect the updated operating status.

Yet further features provide for the method to include receiving, from the consumer device, an arrival indication message indicating the consumer's arrival at the merchant outlet; for the arrival indication message to be received in response to the consumer inputting an arrival indication into the consumer device at the time of arrival at the merchant outlet; for the arrival indication message to include an updated current geographical location of the consumer device, for the method to include comparing the updated current geographical location with the geographical location at which the merchant outlet is physically located so as to verify the consumer's arrival at the merchant outlet; and for the method to include, if the updated current geographical location of the consumer device falls outside of a predetermined range of the geographical location at which the merchant outlet is physically located, transmitting an arrival validation request message to the consumer device, the arrival validation request message prompting the consumer to validate arrival at the merchant outlet by performing an arrival validation operation.

The arrival indication message may only be activated by the consumer once the consumer is within a predetermined range of the geographical location at which the merchant outlet is physically located. An override function may be provided to allow the consumer to validate arrival at the merchant outlet by performing an arrival validation operation.

A further feature provides for the method to include transmitting an item release instruction message configured to instruct a storage compartment physically located at the merchant outlet to open. The item release instruction message may be transmitted to the merchant device, which is configured to use the item release instruction message to instruct opening of the storage compartment. Alternatively, the item release instruction message may be transmitted to the consumer device, which is configured to use the item release instruction message to instruct opening of the storage compartment.

A still further feature provides for the method to include providing, to the merchant device, a software application configured to execute on the merchant device and enable receiving and transmitting of messages from and to one or both of the server computer and a control unit associated with a storage compartment physically located at the merchant outlet.

An even further feature provides for the method to include providing, to the consumer device, a software application configured to execute on the consumer device and enable receiving and transmitting of messages from and to the server computer.

In accordance with a further aspect of the invention, there is provided a system including a server computer comprising: a processor and a memory configured to provide computer program instructions to the processor to execute functions of components; a location data message receiving component for receiving, from a consumer device, a location data message including a destination geographical location towards which a consumer associated with the consumer device is destined to travel; an identifying component for identifying a merchant outlet physically located at a geographical location related to the destination geographical location; an item selection receiving component for receiving, from the consumer device, a selection of an item purveyed by the identified merchant outlet; and, an order request component for generating and transmitting, to a merchant device associated with the merchant outlet, an order request message including an indication of the selected item, the order request message ordering the selected item from the merchant outlet for collection by the consumer.

A further feature provides for the system to include the merchant device, comprising: a processor and a memory configured to provide computer program instructions to the processor to execute functions of components; a messaging component for receiving, from the server computer, the order request message including the indication of the selected item; and, a control unit interface component for receiving and transmitting messages from and to a control unit of a storage compartment physically located at the merchant outlet.

A still further feature provides for the system to include the control unit, comprising: a processor and a memory configured to provide computer program instructions to the processor to execute functions of components; a merchant device interface component for receiving and transmitting messages from and to the merchant device; and, an input and output component for interfacing with modules of the storage compartment, including outputting a control signal to control opening of the storage compartment.

In accordance with a further aspect of the invention there is provided a computer program product comprising a computer-readable medium having stored computer-readable program code for performing the steps of: receiving, from a consumer device, a location data message including a destination geographical location towards which a consumer associated with the consumer device is destined to travel; identifying a merchant outlet physically located at a geographical location related to the destination geographical location; receiving, from the consumer device, a selection of an item purveyed by the identified merchant outlet; and, generating and transmitting, to a merchant device associated with the merchant outlet, an order request message including an indication of the selected item, the order request message ordering the selected item from the merchant outlet for collection by the consumer.

Further features provide for the computer-readable medium to be a non-transitory computer-readable medium and for the computer-readable program code to be executable by a processing circuit.

In accordance with a further aspect of the invention, there is provided a computer-implemented method conducted at a server computer and comprising: receiving, from a consumer device, identification of a merchant outlet, the merchant outlet being associated with a geographical location at which it is physically located; validating that the consumer device is physically located within a predetermined range of the geographical location of the merchant outlet; receiving, from the consumer device, selection of an item purveyed by the identified merchant outlet; and, transmitting, to a merchant device associated with the merchant outlet, an order request message including an indication of the selected item, the order request message ordering the selected item from the merchant outlet for collection by the consumer.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for remotely ordering and dispensing items for collection according to aspects of the present disclosure;

FIG. 2 is a flow diagram which illustrates initial and data record maintenance steps which may be performed by a server computer according to aspects of the present disclosure;

FIG. 3A is a swim-lane flow diagram in which a first exemplary method for remotely ordering items for collection is illustrated according to aspects of the present disclosure;

FIG. 3B is a swim-lane flow diagram in which a second exemplary method for remotely ordering items for collection is illustrated according to aspects of the present disclosure;

FIG. 4 is a swim-lane flow diagram in which an exemplary method for storing and dispensing items for collection is illustrated according to aspects of the present disclosure;

FIG. 5 is a flow diagram which illustrates an exemplary method for controlling opening and closing of a door of a storage compartment according to aspects of the present disclosure;

FIG. 6 is a three dimensional view of an exemplary storage compartment unit including a number of storage compartments according to aspects of the present disclosure;

FIG. 7 is a block diagram which illustrates components of an exemplary system for remotely ordering and dispensing items for collection according to aspects of the present disclosure; and

FIG. 8 illustrates an example of a computing device in which various aspects of the disclosure may be implemented.

### DETAILED DESCRIPTION WITH REFERENCE TO THE DRAWINGS

Aspects of the present disclosure relate to a system and method for remotely ordering items for collection. Particular aspects of the present disclosure address the identification of outlets based on geographical location. For example, in embodiments described herein, a geographical location associated with a destination to which a consumer is destined to travel may be used to identify merchant outlets from which items, such as fast food, may be ordered. As one example, a consumer may be travelling to his or her place of employment and a merchant outlet that is most convenient when considering this destination may be identified and proposed to the consumer.

Aspects of the present disclosure are primarily directed towards the ordering and collection of food-related items, in particular fast food and drink items. However, it should be appreciated that the described system and method may be used for the ordering and collection of other items of convenience, such as groceries and other consumables and/or commodities.

Aspects of the present disclosure may enable pre-placement of an order for a consumer, via a mobile software application, in conjunction with the use of boxes or storage compartments as the means of distribution. This may provide access to items such as fast food products without needing to require any one or more of: physical payment in at the merchant outlet (i.e. the store); physical queuing at the merchant outlet to collect the items; and, any physical interaction with the servicing staff of an outlet. This may lead to improvements in the ease and convenience of ordering and collecting items such as fast food. In addition, consumers may be able to plan their time more efficiently and save time too.

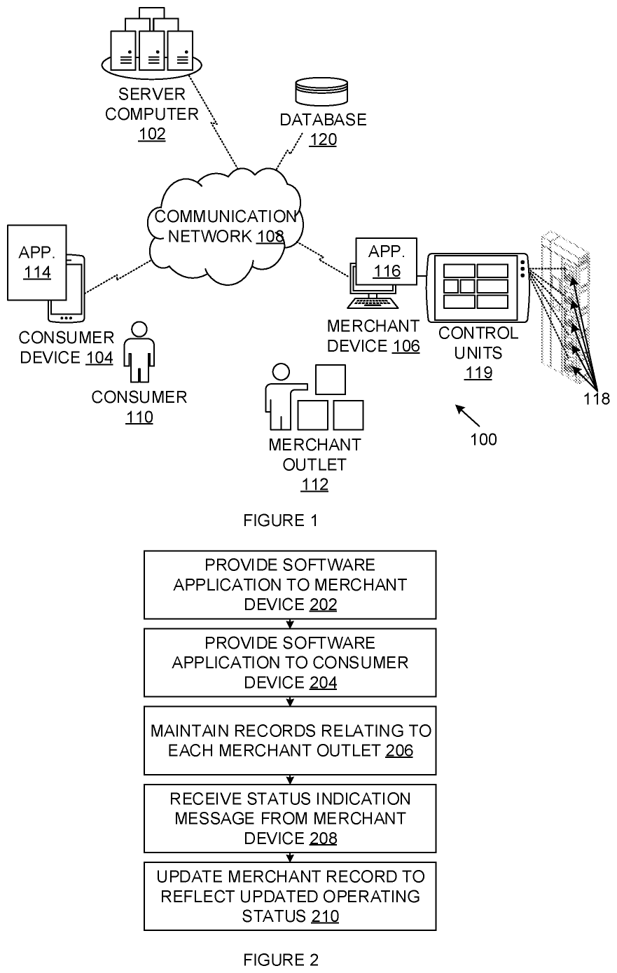

FIG. 1 is a schematic diagram which illustrates an exemplary system (100) for remotely ordering items for collection. The system (100) may include a server computer (102), a consumer device (104) and a merchant device (106). The server computer (102) may be in communication with each of the devices (104, 106) via a suitable communication network (108), such as the Internet. Communication between respective devices on the communication network (108) may be via a secure channel, such as TLS, SSL or the like.

The consumer device may be associated with a consumer (110). The merchant device may be associated with a merchant outlet (112) which purveys items for consumption by consumers. Although only one consumer and one merchant outlet are illustrated, it should be appreciated that in a practical implementation there may be a plurality of each of these.

The consumer device (104) may be operated by the consumer (110) and may be provided by any suitable computing device capable of communicating on the communication network (108). The consumer device may be portable and may for example be in the form of a smartphone, tablet computer, personal digital assistant, wearable computing device or the like. The consumer device (102) may execute a software application (114) which may enable receiving and transmitting of messages from and to the server computer. The consumer device may be configured to transmit location data and a selection of an item purveyed by the merchant outlet to the server computer. The consumer device may further be configured to transmit to the server computer an arrival indication message indicating the consumer's arrival at the merchant outlet.

The merchant device (106) may be physically located at the merchant outlet (112). The merchant device (106) may be provided by any appropriate computing device which is capable of communicating on the communication network (108). The merchant device may for example be in the form of a point-of-sale (POS) terminal or may otherwise be in the form of a portable computing device, such as a smartphone, tablet computer, personal digital assistant, wearable computing device or the like.

The merchant device (106) may execute a software application (116) which may enable receiving and transmitting of messages from and to one or both of the server computer and control units (119) associated with storage compartments (118) which are physically located at the merchant outlet. The control units (119) may be provided by programmable logic controllers (PLCs) and the merchant device may interface with the control units via a PCL network. The software application (116) and associated control units may implement a supervisory control and data acquisition (SCADA) architecture for high-level process supervisory management of and interfacing with the storage compartments.

The merchant device may be configured to control operation of the storage compartments by transmitting instruction messages to the control units (119) associated with the storage compartments. For example, the merchant device may be able to control opening, closing, heating or cooling of the storage compartments, and the like. Each storage compartment may thus operate as a dispenser via which items ordered by consumers can be dispensed.

The merchant device (106) may be configured to receive an order request message from the server computer (102). The order request message may include an indication of an item selected by the consumer. Upon receiving the message, the merchant outlet may commence preparing the item for collection by the consumer. Once prepared the item may be placed inside a storage compartment for collection therefrom by the consumer.

The server computer (102) may be provided by a computing device performing a server role. In some implementations, the server computer may be a cloud-based server computer, the physical location of which may be irrelevant to the functionality of the described system and method.

The server computer (102) may have access to one or more databases (120) in which information may be stored and from which information may be accessed. The database (120) may include records of consumers and merchant outlets who have registered to make use of the system.

Each consumer record may include a consumer identifier which uniquely identifies the consumer. In some cases consumer authentication information (e.g. username and password), consumer profile information (e.g. name, residential address, etc.), payment information for processing of payments against a financial account associated with the consumer (e.g. bank card details or wallet service information) and the like may be stored in the consumer record in association with the consumer identifier.

Each merchant record may include a merchant identifier which uniquely identifies the merchant outlet. The merchant record may also store a geographical location at which the merchant outlet is physically located. This may be in the form of a street address and/or coordinates (e.g. GPS coordinates). The merchant record may also store an operating status (e.g. one of ‘open’, closed’, etc.). The operating status may be configurable by the merchant outlet. The merchant record may further include financial account information usable in processing payments in favor of a financial account associated with the merchant outlet. The merchant record may further include a list of items purveyed by the merchant. The list may for example be in the form of a menu and each item may be associated with a price. The list of items may also include one or more images and or descriptions associated with each item, the images typically representing the items with which they are associated.

The system (100) described above may be configured to facilitate remote ordering of items by consumers from merchant outlets for collection from the merchant outlet by the consumer. The system (100) may implement a method for remotely ordering items for collection.

Exemplary methods for remotely ordering items for collection is illustrated in the flow diagrams of FIGS. 2 to 5. FIG. 2 is a flow diagram which illustrates initial and data record maintenance steps which may be performed by the server computer (102). Some of the Figures are swim-lane flow diagrams in which the swim lanes delineate respective operations, steps or procedures performed by respective devices.

The server computer (102) may provide (202) to the merchant device (106) a software application (116) configured to execute on the merchant device (106) and enable receiving and transmitting of messages from and to one or both of the server computer and a control unit (119) associated with a storage compartment (118) physically located at the merchant outlet. The software application may be provided via a software application repository, such as an ‘APP STORE’ (a trade mark of Apple, Inc.), for downloading and installing on the merchant device.

The server computer (102) may provide (204) to the consumer device (104) a software application (114) configured to execute on the consumer device and enable receiving and transmitting of messages from and to the server computer. The software application may similarly be provided via a software application repository for downloading and installing on the consumer device. Providing the application may include populating a locally stored record of merchant outlets and associated lists of items purveyed by the respective merchant outlets. The locally stored record may be updated by the server computer from time-to-time.

The server computer (102) may maintain (206) records relating to each merchant outlet. The records may be maintained in the database (120). As mentioned above, each merchant record may include a geographical location at which the merchant outlet is physically located and an operating status.

The remote server (102) may from time-to-time receive (208) a status indication message from the merchant device (106). The status indication message may indicate a change in the operating status of the merchant outlet and may include the merchant identifier which uniquely identifies the merchant. For example, the merchant outlet may use the merchant device to transmit a status indication message indicating that the merchant outlet is now open or closed for business, as the case may be.

In response to receiving such a message, the server computer (102) may update (210) the merchant record to reflect the updated operating status. For example, the server computer may toggle the operating status from ‘open’ to ‘closed’, or vice versa, as the case may be. This may include querying the database (120) to identify the merchant record associated with the merchant identifier and updating the associated operating status accordingly.

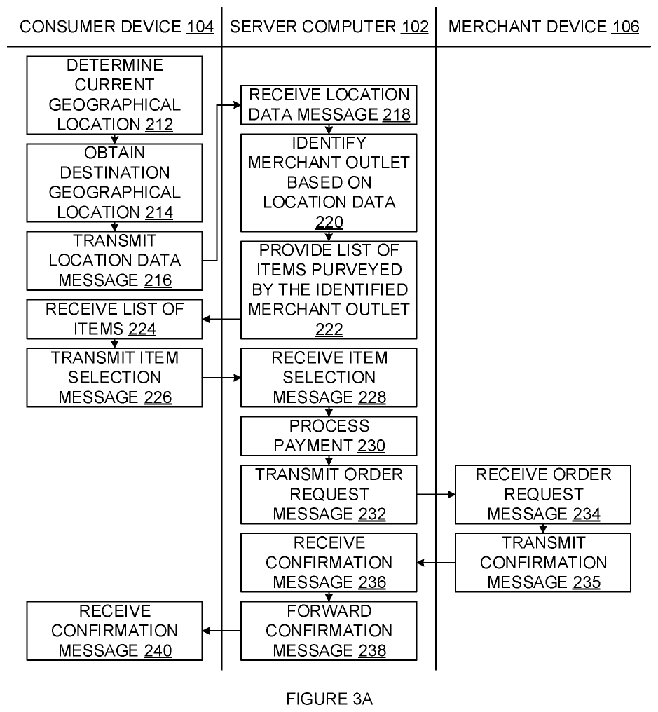

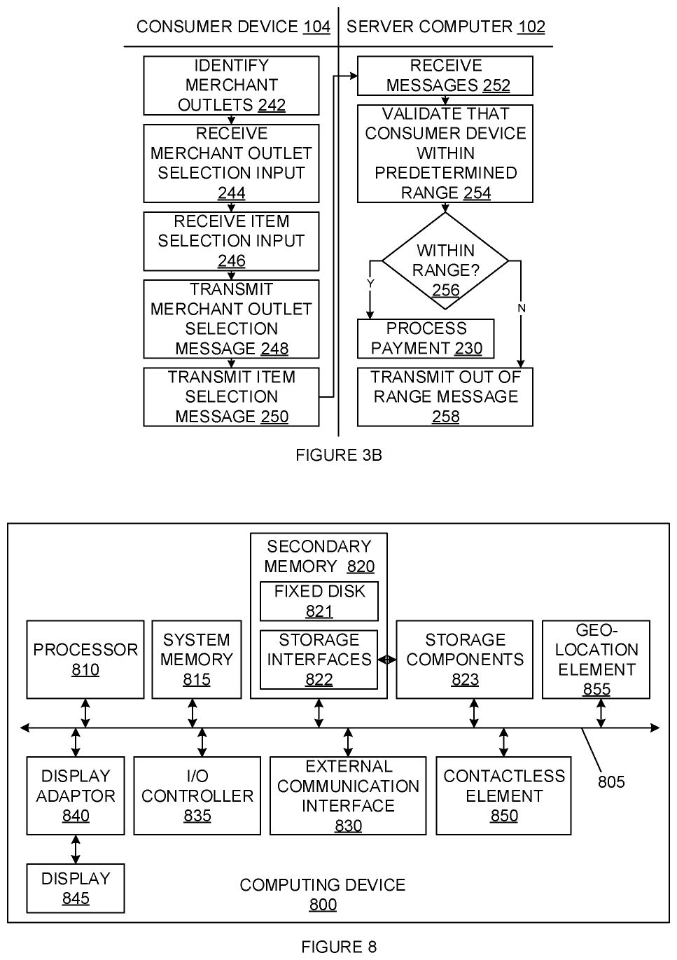

At some stage, the consumer (110) may wish to order an item for collection. FIG. 3A illustrates one exemplary method for remotely ordering items for collection in which a consumer may be preparing to travel towards a destination and may desire to collect an item of interest along the way. As one example, the consumer may be at his or her home and about to commence his or her daily commute to work. The consumer may desire to order and collect an item on the way to the destination and may launch the software application (114) resident in and installed on his or her consumer device (104) to effect this.

Upon launching the application (114), the consumer device (104) may determine (212) its current geographical location. Determining the current geographical location may use a geographical location element associated with the consumer device (104).

The consumer device may also obtain (214) a destination geographical location being associated with a destination to which the consumer is destined to travel. Obtaining the destination geographical location may include prompting for and receiving from the consumer input as to the consumer's destination. In other cases, obtaining the destination geographical location may include accessing an expected destination geographical location, e.g. from a ‘maps destinations’ feature of the consumer device, a calendar associated therewith, and the like. The expected destination geographical location may be based on historic geographical location data collected by the consumer device over time. In some implementations, the consumer device may generate a prompt associated with the destination geographical location, for example “Would you like to order an item for collection on your way to work?”

The consumer device (104) may generate and transmit (216) a location data message to the server computer (102). The location data message may include geographical location data, including one or both of the current geographical location and the destination geographical location. The location data message may also include the consumer identifier to identify the consumer to the server computer.

The server computer (102) may receive (218) the location data message from the consumer device (104). The server computer (102) may determine whether or not the consumer is a registered consumer (e.g. by querying the database using the consumer identifier). If not a registered consumer, the server computer may direct the consumer to a registration page for registration with the system. In some cases, in response to connection of the consumer device to the server computer, the server computer may update item lists stored locally at the consumer device.

The server computer (102) may identify (220) a merchant outlet based on the geographical location data included in the location data message. This may include identifying a merchant outlet physically located at a geographical location which is related to one or both of the destination geographical location and the current geographical location. The geographical location of the merchant outlet may be related to the geographical location data in that the destination geographical location is in the same general direction as the merchant outlet relative to the current geographical location of the of the consumer device. In some implementations, identifying (220) the merchant outlet may include identifying a merchant outlet physically located at a geographical location falling within a predetermined range of the geographical location data included in the location data message. This may include identifying a merchant outlet which is physically located proximate the current geographical location, the destination geographical location or a route extending between the current and destination geographical locations. Identifying merchant outlets may include querying an operating status associated with each of the potential merchant outlets to determine whether or not the merchant outlet is available.

Identifying (220) the merchant outlet may include identifying a merchant outlet physically located at a geographical location falling within a predetermined range of a route between the current geographical location and destination geographical location. The server computer may determine one or more possible routes between the geographical locations and may identify merchant outlets which are located along, or a short detour from, one or more of these routes. If multiple merchant outlets are located within the predetermined range, then each of these multiple merchant outlets may be identified and considered. In some cases, a route may be suggested which best accommodates possible merchant outlets or the identified merchant outlet.

The server computer (102) may provide (222), to the consumer device (104), a list of items purveyed by the identified merchant outlet (or outlets). The list of items may be stored at the consumer device and providing the list of items may include the server computer generating and transmitting an item list pointer message which points to the relevant items lists stored in the consumer device (104). In other implementations, providing the list of items may include the server computer generating and transmitting an item list message to the consumer device for each of the identified merchant outlets. The list of items may include, for each item, an item identifier, item description, an amount (e.g. price) and the like.

In some implementations, multiple merchant outlets may be identified and providing the list of items may be in response to the consumer selecting one of the identified merchant outlets. Identified merchant outlets may for example be displayed on a map to the consumer via a display associated with the consumer device and the consumer may be able to select from the identified merchant outlets by selecting an icon displayed on the map and representing that merchant outlet. Upon selecting a merchant outlet, the consumer may be provided with a list of items purveyed by that merchant outlet for selection of an item for ordering.

The consumer device may receive (224) the list of items from the server computer (102). This may be via an item list pointer message or an item list message, as the case may be. The consumer device may display the list of items to the consumer for his or her input as to an item selection. The list of items may for example be in the form of a menu, and each item in the list may be associated with a price and may be configured for selection/deselection by the consumer. Where multiple merchant outlets are identified, the consumer may be able to select between respective lists of items associated with each of the merchant outlets. The consumer device may receive input in the form of selection by the consumer of one or more items in the list of items associated with the identified merchant outlet (or outlets). In some implementations, the consumer may also input a collection time into the consumer device, being a time at which the consumer expects to arrive at the merchant outlet to collect the item. In other implementations, the consumer device may generate an expected collection time based on the current location and the geographical location associated with the merchant outlet (112).

In some cases, consumer input may be received by way of a microphone and an associated voice recognition component of the consumer device. The voice recognition component may for example allow the consumer to input the item selection and other data and/or information into the consumer device by dictating the item selection, data and/or information.

The consumer device (104) may generate and transmit (226) an item selection message to the server computer (102). The item selection message may include a selection of one or more items purveyed by the one or more identified merchant outlets. The item selection may be a selection from the list of items. The item selection message may include one or more of the item identifier, item description, amount, consumer identifier, merchant identifier, a collection time and the like.

The server computer (102) may receive (228) the selection of the one or more items purveyed by the one or more identified merchant outlets from the consumer device (104). The selection of the items may be received in an item selection message. The item selection may be associated with an amount. Receiving the item selection message may therefore receive the consumer's order of the items from the merchant outlet.

In some implementations, the server computer may receive an expected time of arrival indication which indicates an expected time of arrival of the consumer at the merchant outlet. The expected time of arrival may have been determined based on one or both of the current geographical location of the consumer device and the destination geographical location or may have been input into the consumer device by the consumer. The server computer may also obtain a grace period associated with the expected time of arrival and by way of which early arrival or late arrival by the consumer for collection of the item is taken into account (within reasonable limits). The grace period may be obtained from the consumer (via input into the consumer device) or may be determined based on geographical location data, normal travel times, traffic indications and the like.

The server computer (102) may process (230) a payment in respect of the amount against a financial account associated with the consumer (110) in favor of a financial account associated with the merchant outlet (112). The server computer may for example store payment information (such as details of the consumer's bank card) and may submit a payment request to a payment processing network in order to process the payment. In some implementations, wallet services (such as PAYPAL, a trade mark of PayPal Holdings, Inc.) may be used to process payments. Processing the payment may include accessing the payment information stored in the database (120) in association with the consumer identifier.

The server computer (102) may generate and transmit (232) an order request message to a merchant device (106) associated with the merchant outlet (112). The order request message may include an indication of the selected item. The order request message may for example include one or more of the item identifier, the item description, the consumer identifier, the merchant identifier and the collection time. In some implementations, the order request message may include confirmation of payment of the item, while in other implementations, payment in respect of the item may be processed after confirmation of receipt of the order. The order request message may have the effect of ordering the selected item from the merchant outlet for collection by the consumer.

The merchant device (106) may receive (234) the order request message from the server computer and may generate and transmit (235) a confirmation message to the server computer (102) the confirmation message confirming receipt of the order request message. In some implementations, the confirmation message may confirm the merchant outlet's ability to complete the order (e.g. confirmation that it has the necessary items or associated ingredients in stock). The order confirmation message may include one or more of the consumer identifier, merchant identifier and item identifier. If required, the confirmation message may include an updated collection time, if for example, the merchant device determines that the selected item will not be ready by the collection time provided by the consumer. The updated collection time may for example indicate a later collection time than initially requested by the consumer. The merchant device may also output an order prompt, for example via a display associated with the device, prompting the merchant outlet to prepare the item (or items) for collection by the consumer (110).

The server computer (102) may receive (236) the confirmation message from the merchant device (106). The server computer (102) may forward (238) the confirmation message to the consumer device. The confirmation message may include an updated collection advising the consumer of a collection time which is different from that input by the consumer or estimated by the server computer.

The consumer device (104) may receive (240) the confirmation message. At some stage, the consumer may commence his or her trip towards the destination. Similarly, the merchant outlet may commence preparing the selected items for collection by the consumer.

The merchant device may periodically transmit updates to the server computer for on-forwarding to the consumer device. The updates may for example include an estimated completion time, a storage compartment identifier identifying the storage compartment in which the ordered item is to be stored, an order status (e.g. ‘in progress’, ‘complete’, etc.) as well as one or more of the merchant identifier, item identifier and consumer identifier.

FIG. 3B illustrates another exemplary method for remotely ordering items for collection. The method of FIG. 3B may find particular application in a so-called “drive-through” or “drive-thru” scenario in which a consumer travelling in his or her car wishes to order and collect items, such as fast food and beverage items. Other use cases may be applicable too.

As one example, the consumer may be in his or her motor car. The consumer may be nearby a merchant outlet from which he or she wishes to order items for collection, or may wish to be advised of proximate merchant outlets. In either event, the consumer may desire to order and collect an item from a nearby merchant outlet and may launch the software application (114) resident in and installed on his or her consumer device (104) to effect this.

Upon launching the application (114), the consumer device (104) may identify (242) merchant outlets from which items can be ordered and collected. Identifying merchant outlets may include identifying merchant outlets which are nearby, for example using the geographical location of the consumer device. This may include requesting and receiving from the server computer (102) a list of merchant outlets falling within a predetermined range of the geographical location of the consumer device (104). In other cases, identifying merchant outlets may include accessing a list of merchant outlets stored in a memory of the consumer device.

The consumer device (104) may receive (244) a consumer selection of a merchant outlet from the one or more identified merchant outlets. The selection may be input by the consumer into the consumer device.

In some implementations, the consumer device may receive (246) input in the form of selection by the consumer of one or more items for collection. The item selection input may be a selection from a list of items purveyed by the selected merchant outlet, which may be fetched from the server computer or from a memory of the consumer device. In some cases, the item selection input may be received by way of a microphone and an associated voice recognition component of the consumer device. The voice recognition component may for example allow the consumer to input the item selection into the consumer device by dictating the item selection.

In some cases, the merchant outlet and item selection may be received by the consumer device contemporaneously. For example, in some implementations, the consumer device may be configured to receive dictation of a merchant outlet and item selection via the microphone and voice recognition component. The consumer may for example be able to dictate “Order me a Super Burger from Fred's Super Burgers” into the consumer device to cause the consumer device to transmit a merchant outlet and item selection message.

The consumer device (104) may transmit (248) a merchant outlet selection message to the server computer (102). The merchant outlet selection message may include the consumer selection of the merchant outlet.

The consumer device (104) may transmit (250) an item selection message to the server computer (102). The item selection message may include a selection of one or more items purveyed by the identified merchant outlet.

One or both of the merchant outlet selection message and the item selection message may include a current geographical location of the consumer device. The current geographical location of the consumer device may have been determined by a geographical location element associated therewith determining the geographical location of the consumer device in response to input of the consumer selection. The current geographical location may thus be linked to the time at which the consumer makes his or her selection of the merchant outlet and/or items for collection. In some cases, the current geographical location may be timestamped with the time at which the geographical location is obtained.

The merchant outlet selection message and the item selection message may also include one or more of the item identifier, item description, amount, consumer identifier, merchant identifier, a collection time and the like, as may be appropriate. In some cases, the consumer's merchant outlet selection and item selection as well as some or all of the above additional information may be transmitted to the server computer in in a single message.

The server computer (102) may receive (252) the merchant outlet selection message and the item selection message (which in some cases may be a single message) from the consumer device (104). As mentioned, one or both of the messages may include the current geographical location of the consumer device (104), which in some cases may be timestamped.

The server computer (102) may validate (254) that the consumer device is within a predetermined range of the selected merchant outlet. This may include comparing the current geographical location of the consumer device against a registered geographical associated with the merchant outlet (i.e. the geographical location at which the merchant outlet is physically located). In some implementations, the predetermined range may be dynamically based on an estimated travel time. For example, the predetermined range may be based on a predetermined minimum travel time and an estimated travel speed. The estimated travel speed may for example take into account traffic conditions, historic data, etc. The predetermined range and/or minimum travel time may be relatively low. For example, the predetermined range may be within a few miles (or less) while the minimum travel time may be in the region of a few minutes (e.g. 10 minutes, 5 minutes or less). In some cases, the predetermined range and/or minimum travel time may be associated with an item preparation time (or average item preparation time). For example, the merchant outlet may on average be able to prepare items for collection within about 5 minutes of receiving an order, in which case the minimum travel time may be 5 minutes or slightly more. The predetermined range and/or minimum travel time may thus be selected to minimize the amount of time that elapses between the item being ready for collection and actually being collected.

If (256) the consumer device is within the predetermined range of the selected merchant outlet, the method may continue as described above with reference to FIG. 3A, with the server computer processing (230) the payment and transmitting (232) an order request message to the merchant device to order the selected item for collection by the consumer. The order request message may include an estimate of the time which it will take the consumer to travel to the merchant outlet to collect the item or may simply confirm that the consumer will be at the merchant outlet for collection of the item within the minimum travel time, the average item preparation time or the like.

If (256) the consumer device is not within the predetermined range of the selected merchant outlet, the server computer may transmit (258) an out of range message to the consumer device to prompt the consumer to select the merchant and/or order the items when the consumer is within the predetermined range. In other implementations, the server computer may place the order on hold and monitor the geographical location of the consumer device until it falls within the predetermined range. Upon the geographical location of the consumer device falling within the predetermined range, the server computer may remove the hold on the order and the method may continue as described above with reference to FIG. 3A, with the server computer processing the payment and transmitting the order request message to the merchant device to order the selected item for collection by the consumer.

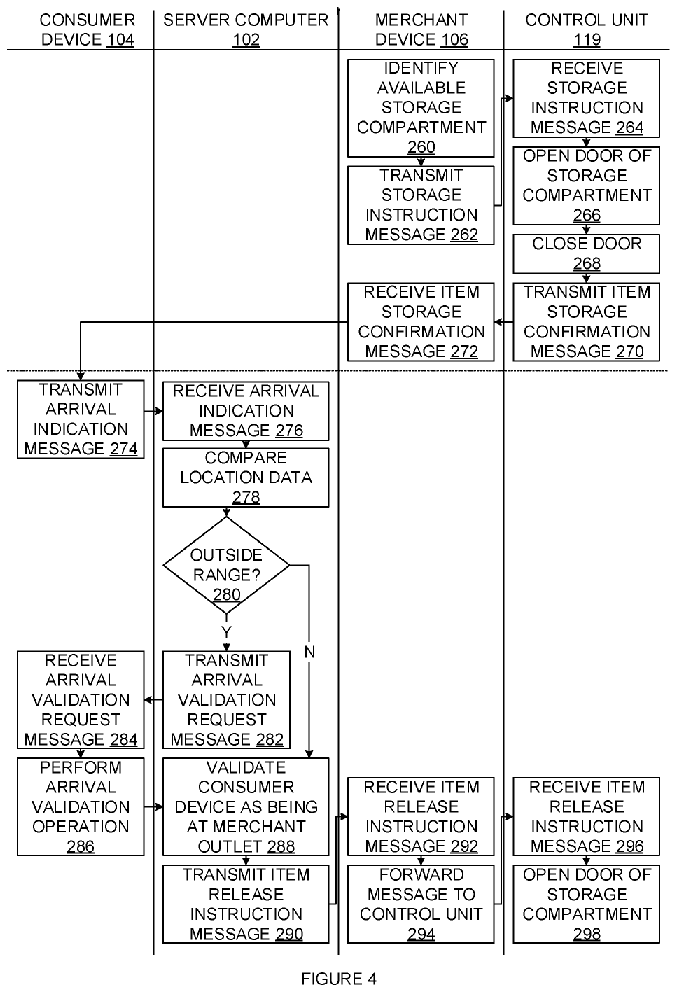

With reference now to FIG. 4, and following on from either the exemplary scenario of FIG. 3A or 3B, once prepared, the merchant outlet (112) may place the item in a storage compartment (118) which is physically located at the merchant outlet. This may include the merchant device (106) identifying (260) an available storage compartment from an array of storage compartments (118). Identifying the storage compartment may include estimating, based on the selected item, an appropriately sized storage compartment. Identifying the storage compartment may include querying a storage compartment list in which storage compartment identifiers of each storage compartment are associated with one or more of a status, a size indication and a consumer identifier identifying the consumer whose item is being stored in the storage compartment.

The merchant device (106) may transmit (262) a storage instruction message to a control unit (119) associated with the identified storage compartment (118). The storage instruction message may be configured to instruct opening of the storage compartment for loading of the item into the storage compartment (118). In some implementations, the instruction message may include settings data configured to control various settings associated with the storage compartment. The storage compartment may for example have a heating and cooling functionality and the settings data may be configured to instruct heating or cooling of the storage compartment based on the item that is to be stored therein. For example, in the case of hot food or beverages, the settings data may instruct heating of the storage compartment, while in the case of a cool drink or ice cream, for example, the settings data may instruct cooling of the storage compartment.

The control unit (119) may receive (264) the storage instruction message. The control unit (119) may open (266) a door of the storage compartment (e.g. by controlling operation of a motor to move a door of the storage compartment from a closed condition into an open condition). The control unit may also control other settings associated with the storage compartment in accordance with settings data included in the message. The control unit (119) may close (268) the door and transmit (270) an item storage confirmation message to the merchant device (106). The item storage confirmation message may indicate that the item has been safely stored and may include one or both of the consumer identifier and the storage compartment identifier which uniquely identifies the storage compartment. In some implementations, the storage instruction message may be input into the control unit by way of a suitable human-machine interface (such as a control panel). In some cases, the settings data may also be input into the control unit by way of the human-machine interface.

The merchant device (106) may receive (272) the item storage confirmation message and may update the storage compartment list accordingly (for example by toggling a status associated with the storage compartment identifier from ‘available’ to ‘occupied’ and/or linking the consumer identifier with the storage compartment identifier). In this manner, the merchant device (106) may be able to keep track of which orders are in which storage compartments and the number of storage compartments that are available.

The merchant device (106) may transmit an item collection instruction to the server computer (102) for forwarding to the consumer device (104). The item collection instruction may include one or more of the consumer identifier, the storage compartment identifier and the item identifier. The consumer device may receive the item collection instruction and may display a notification to the consumer advising that the item is ready for collection.

The server computer (102) may at some stage determine that the consumer (110) has arrived at the merchant outlet (112). In some implementations, the consumer may use his or her consumer device to input an arrival indication. The indication may be received via the user inputting the indication into the device via a touch-sensitive display (e.g. selecting an “I have arrived” button), tapping a contactless element (or otherwise accessing a token) located at and associated with the merchant outlet, or the like. In some implementations the merchant outlet and consumer device may use geo-fencing technology for automatic input of the arrival indication upon the consumer arriving at the merchant outlet.

In response to receiving the input, the consumer device (104) may generate and transmit (274) an arrival indication message. The arrival indication message may include one or more of the consumer identifier, merchant identifier and item identifier and may indicate the consumer's arrival at the merchant outlet. In some implementations, generating the arrival indication message may include the consumer device determining its updated current geographical location using the associated geographical location element. The consumer device may include the updated current geographical location for verification against a registered geographical location of the merchant outlet.

In some implementations, the arrival indication message may only be activated by the consumer once the consumer is within a predetermined range of the geographical location at which the merchant outlet is physically located. The consumer device may for example receive geographical location data associated with the geographical location of the merchant outlet and may evaluate the updated current geographical location of the consumer device against this geographical location data. Only once the consumer device is within a predetermined range (e.g. 30 m) of the merchant outlet will an arrival indication input (e.g. graphical button) be enabled for activation by the consumer to instruct transmission of the arrival indication message. An override function may be provided to allow the consumer to validate arrival at the merchant outlet by performing an arrival validation operation (e.g. as described in greater detail below).

The server computer (102) may receive (276) the arrival indication message indicating the consumer's arrival at the merchant outlet (112). As mentioned, the arrival indication message may be received in response to the consumer inputting an arrival indication into the consumer device at the time of arrival at the merchant outlet.

Where the arrival indication message includes the updated current geographical location of the consumer device (104), the server computer (102) may compare (278) the updated current geographical location received from the consumer device (104) with the geographical location at which the merchant outlet (110) is physically located, so as to verify the consumer's arrival at the merchant outlet. This may ensure that the storage compartment can only be opened with the consumer being within a predetermined range (e.g. in some cases in the order of 5 yards) of the storage compartment.

If (280) the updated current geographical location of the consumer device (104) falls outside of a predetermined range of the geographical location at which the merchant outlet is physically located, the server computer (102) may transmit (282) an arrival validation request message to the consumer device (104). The arrival validation request message may include one or more of the consumer identifier, merchant identifier, item identifier and storage compartment identifier. The arrival validation request message may prompt the consumer to validate arrival at the merchant outlet by using the consumer device to exchange a digital token with the merchant device (106) and/or control unit (119).

For example, in some implementations, an optical device for capturing a graphical code, such as a quick response (QR) or barcode scanner, may be associated with the storage compartment. The consumer device may be able to generate a graphical code (e.g. QR code, barcode, etc.), including e.g. the consumer identifier for capturing by the optical device to validate that the consumer is physically proximate the storage compartment. In other implementations, a graphical code may be associated with the storage compartment for capturing by the consumer device and onward transmission to the server computer to validate that the consumer is physically proximate the storage compartment.

The consumer device (104) may receive (284) the arrival validation request message and may perform an arrival validation operation (286), such as displaying a barcode or capturing a digital token associated with the storage compartment and/or merchant outlet. The arrival validation operating may include the consumer device exchanging the digital token with the server computer (102), optionally via the merchant device to confirm that the consumer device is physically located at the merchant outlet and ready to collect the item.

Responsive to the consumer device performing the arrival validation operation, the server computer may validate (288) the consumer device as being at the merchant outlet.

If (280) the updated current geographical location of the consumer device (104) falls within the predetermined range of the geographical location at which the merchant outlet is physically located, the server computer (102) may validate (288) the consumer device as being at the merchant outlet.

Once the consumer device has validated that it is physically located at the merchant outlet and/or storage compartment, the server computer (102) may generate and transmit (290) an item release instruction message. In the described embodiment, the item release instruction message may be transmitted to the merchant device (104), which may be configured to use the item release instruction message to instruct opening of the storage compartment. The item release instruction message may be configured to instruct the storage compartment physically located at the merchant outlet to open. The item release instruction message may include one or more of the consumer identifier, merchant identifier, storage compartment identifier and item identifier.

In other embodiments, the item release instruction message may be transmitted to the consumer device, which may be configured to use the item release instruction message to instruct opening of the storage compartment. The item release instruction message may for example include a digital token for providing to the control unit of the storage compartment for validation by the control unit, upon which the control unit may open the storage compartment to provide access to the item contained therein to the consumer. The digital token may for example be proved to the control unit by way of a graphical code for optical capturing, using near field communication or the like.

The merchant device (104) may receive (292) the item release instruction message and may forward (294) the item release instruction message to the control unit of the storage compartment to which the message relates. This may include identifying the relevant storage compartment by querying the storage compartment list maintained by the merchant device, using, for example, the consumer identifier and/or storage compartment identifier included in the message. Forwarding the message may include transmitting an instruction message to the control unit which is configured to cause the control unit to open the storage compartment. In other embodiments, the control unit may receive the item release instruction message from the consumer device.

The control unit (119) may receive (296) the item release instruction message (or instruction) from the merchant device (104) and may output (298) a control signal to control opening of the storage compartment. The control signal may for example be output to a motor controller and may cause the motor to operate to open the door of the storage compartment.

Once open, the consumer (110) may be able to remove the item from the storage compartment (118) and continue on his or her journey towards the destination geographical location. The control unit may be configured to automatically close the door to the storage compartment once the item has been removed and/or after a predetermined time period has expired.

The server computer (102) may close an order process to finalize the transaction and save it to the database (120).

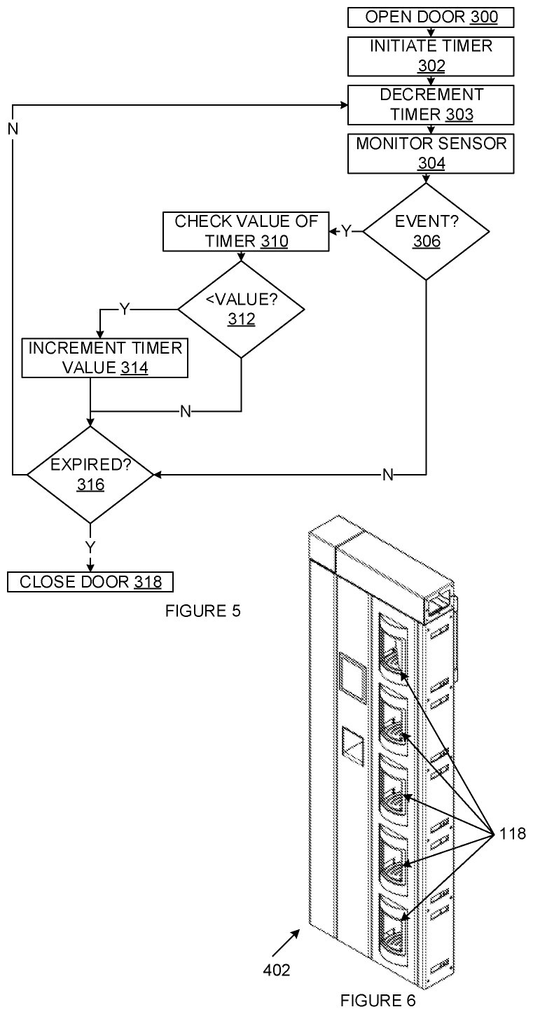

For example, with reference to FIG. 5, the control unit may open (300) the door of the storage compartment and initiate (302) a timer configured to time a predetermined amount of time (e.g. 25 seconds). The control unit may periodically decrement (303) the timer to count down by the predetermined amount of time.

The control unit (119) may monitor (304) a sensor associated with the storage compartment (118) for the detection of an event. The sensor may include one or both of a proximity sensor, a threshold detection sensor, a presence or movement sensor and the like. A proximity sensor may be configured to detect proximity of an object, such as an item, to the sensor. A threshold detection sensor may be configured to detect the passage of an item across a threshold and may for example be provided by an infrared beam which is projected across an opening of the storage compartment. An item entering the opening may break the beam and such ingress may thus be detected by the sensor. A presence or movement sensor may be configured to detect the presence or movement of an item, such as a hand of a consumer, and may be provided by a passive infrared sensor.

If (306) an event is detected, the control unit (119) may check (310) the value of the timer (i.e. the amount of time remaining on the timer). If (312) the timer is within a predetermined amount of time from expiry (for example if there are 5 seconds or less remaining on the timer), the control unit may increment (314) the value of the timer by a predetermined amount (e.g. the 10 seconds may be added to the timer value). While an event is being detected, the control unit may keep the door open for as long as the event is detected. For example, in the case of a threshold detection sensor, the event may be the ingress of a consumer's hand into the storage compartment causing the beam of the sensor to break. For as long as the beam is broken (indicating the hand being in the storage compartment) the control unit may keep the door open.

Once (316) the timer has expired, and if no event is being detected, the control unit may close (318) the door. In response to closing the door, the control unit may toggle the status of the storage compartment from ‘occupied’ to one or ‘available’ or ‘clean required’, as may be appropriate. Toggling the status may include transmitting a status update message to the merchant device to cause the merchant device to update the storage compartment list maintained thereat and may include outputting a status indication via a visual status indicator associated therewith.

FIG. 6 illustrates an exemplary storage compartment unit (402) which includes a plurality of storage compartments (118). In some implementations, the storage compartment unit (402) may be configured to be connected to other storage compartment units to form a storage compartment wall. In some implementations, the storage compartment wall may form a part of a perimeter wall of a building occupied by the merchant outlet. Each storage compartment (118) may be accessible from each side of wall so that consumers can access items located within the storage compartments without entering the building. Similarly, employees of the merchant outlet may be able to place items into storage compartments from within the merchant outlet (e.g. within the building).

Each storage compartment (118) may be associated with a controller unit which is arranged to control operation and other parameters associated with the storage compartment. The control unit may for example be configured to control operation of a motor associated with the storage compartment so as to open and close a door of the storage compartment. The controller unit may be configured to open a merchant entrance and a consumer entrance respectively, depending on who needs to access the storage compartment. The control unit may further be configured to control heating and/or cooling of the storage compartment. In some implementations, the storage compartment may be associated with a visual status indicator, such as an LED light, and the control unit may be configured to toggle the light to indicate different statuses, such as ‘available’ (e.g. green light), ‘occupied’ (e.g. a blue light), ‘clean required’ (e.g. an orange light) or the like.

The motor associated with each storage compartment may be a servo-type motor, or the like. The motor may be torque limited to prevent accidental damages to consumers. The torque limitation may be selected based on the physical parameters of the door so as to provide a suitably safe storage compartment. As mentioned above, each storage compartment may also be associated with one or more sensors to detect occupancy of the compartment and/or the presence of a user's hand, etc. The sensor may serve as a safety device, picking up any movement across the entry of the compartment. The compartment may have a minimum time open function, after which, if the sensor is not interrupted, the compartment will close.

Surfaces of the storage compartment which under normal operation come into contact with items and/or body parts of users may be made from suitable food-grade materials. In some implementations, the door of the storage compartment may be configured to open a consumer entrance and merchant entrance respectively, depending on how the motor is operated. The door may for example be cylindrical in shape and may have an opening defined therein. Rotation of the door in a first direction by a sufficient amount may align the opening of the door with a merchant opening. Rotation of the door in a second direction by a sufficient amount may align the opening of the door with a consumer opening. The door may include transparent portions to allow consumers and/or merchants to see into the storage compartment when the door is closed.

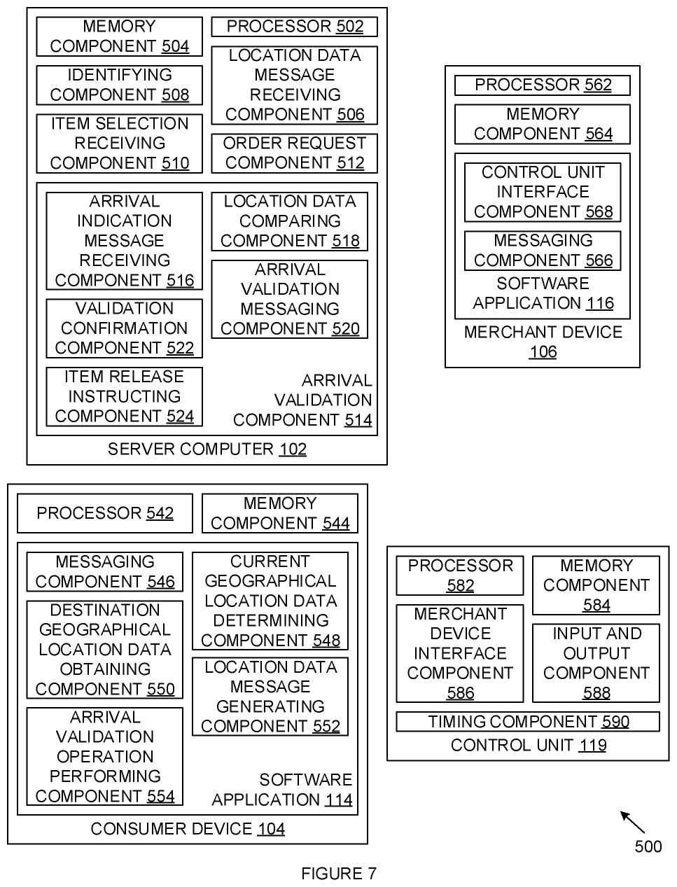

Various components may be provided for implementing methods described above with reference to FIGS. 2 to 5. FIG. 7 is a block diagram which illustrates exemplary components which may be provided by a system (500) for remotely ordering and dispensing items for collection. The system may include a server computer (102), a consumer device (104), a merchant device (106) and a control unit (119) associated with a storage compartment.

The server computer (102) may include a processor (502) for executing the functions of components described below, which may be provided by hardware or by software units executing on the server computer (102). The software units may be stored in a memory component (504) and instructions may be provided to the processor (502) to carry out the functionality of the described components.

The server computer (102) may include a location data message receiving component (506) arranged to receive a location data message from a consumer device. The location data message may include location data including one or both of a current geographical location and a destination geographical location towards which a consumer associated with the consumer device is destined to travel.

The server computer (102) may include an identifying component (508) arranged to identify a merchant outlet physically located at a geographical location related to one or both of the destination geographical location and the current geographical location. This may include identifying a merchant outlet physically located at a geographical location falling within a predetermined range of one or more of the current geographical location, the destination geographical location and a route between the current and destination geographical locations.

The server computer (102) may include an item selection receiving component (510) arranged to receive a selection of an item purveyed by the identified merchant outlet. The item selection may be received from the consumer device.

The server computer (102) may include an order request component (512) arranged to generate and transmit an order request message. The order request message may be transmitted to a merchant device (106) associated with the merchant outlet and may include an indication of the selected item. The order request message may have the effect of ordering the selected item from the merchant outlet for collection by the consumer.

The server computer (102) may include an arrival validation component (514) which may be arranged to validate arrival of the consumer at the merchant outlet. The arrival validation component (514) may include an arrival indication message receiving component (516) which is configured to receive an arrival indication message from the consumer device. The arrival validation component (514) may include a location data comparing component (518) arranged to compare an updated current geographical location received in the arrival indication message to a stored geographical location associated with the merchant outlet. The arrival validation component (514) may include an arrival validation messaging component (520) arranged to exchange messages with the consumer device if the geographical locations are outside of a predetermined range of each other. The arrival validation component (514) may include a validation confirmation component (522) arranged to validate the consumer device as being at the merchant outlet in response to the consumer device successfully performing an arrival validation operation. The validation operation may for example include the merchant device outputting or acquiring a digital token which may be provided to the server computer for validation. The arrival validation component (514) may include an item release instructing component (524) arranged to instruct the merchant device (106) to release the item stored in a storage compartment at the merchant outlet.

The server computer (102) may include any further components that may be required to perform the steps, operations or procedures of the method described above.

The consumer device (104) may include a processor (542) for executing the functions of components described below, which may be provided by hardware or by software units executing on the consumer device (104). The software units may be stored in a memory component (544) and instructions may be provided to the processor (542) to carry out the functionality of the described components. Some or all of the components may be provided by a software application (114) downloadable onto and executable on the consumer device (104).

The consumer device (104) may include a messaging component (546) arranged to exchange messages with the server computer (102).

The consumer device (104) may include a current geographical location data determining component (548) arranged to determine a current geographical location of the consumer device (104). The current geographical location determining component (548) may use a geographical location element associated with the consumer device (104) to determine the current geographical location.

The consumer device (104) may include a destination geographical location data obtaining component (550) arranged to obtain a destination geographical location towards which the consumer is destined to travel. The destination geographical location data obtaining component (550) may be arranged to obtain the destination from one of a plurality of possible sources. The destination geographical location data obtaining component (550) may for example be configured to prompt the consumer for input of a destination geographical location via an input device associated with the consumer device. The destination geographical location data obtaining component (550) may be configured to access calendar data records stored in or in association with the consumer device (104) to obtain a destination geographical location. For example, the consumer may have an upcoming event stored in his/her calendar with location data relating to the location at which the event is to take place. The destination geographical location data obtaining component (550) may obtain the location from the calendar event and may simply prompt the consumer for confirmation of the destination geographical location. The destination geographical location data obtaining component (550) may obtain the destination geographical location from a ‘maps destinations’ function on the consumer device, which estimates based on historic data where the consumer is likely to be headed next. In such a case, the destination geographical location data obtaining component (550) may simply prompt the consumer to confirm the destination geographical location.

The consumer device (104) may include a location data message generating component (552) which may be arranged to generate a location data message including one or both of the current geographical location and the destination geographical location.

The consumer device (104) may include an arrival validation operation performing component (554). The arrival validation operation performing component may be configured to perform an arrival validation operation which validates the consumer's arrival at the merchant outlet. The arrival validation operation performing component may for example be configured to output a digital token for acquisition by the merchant device, control unit and/or a beacon or may be configured to acquire a digital token being output by the merchant device, control unit and/or a beacon. The digital token may be provided to the server computer and/or merchant device for validation of the consumer's arrival at the merchant outlet. The validation operation performing component (554) may for example interface with a contactless element, microphone, speaker, display and the like for output or acquisition of the digital token.

The merchant device (106) may include a processor (562) for executing the functions of components described below, which may be provided by hardware or by software units executing on the merchant device (106). The software units may be stored in a memory component (564) and instructions may be provided to the processor (562) to carry out the functionality of the described components. Some or all of the components may be provided by a software application (116) downloadable onto and executable on the merchant device (106).

The merchant device (106) may include a messaging component (566) arranged to exchange messages with the server computer (102).

The merchant device (106) may include a control unit interface component (568) arranged to interface with the control unit (119) and to receive and transmit messages from and to the control unit (119) of a storage compartment physically located at the merchant outlet. The merchant device (106) may be configured to monitor the storage compartments (via the respective control units) for errors and output and alert as may be required.

The control unit (119) may include a processor (582) for executing the functions of components described below, which may be provided by hardware or by software units executing on the control unit (119). The software units may be stored in a memory component (584) and instructions may be provided to the processor (582) to carry out the functionality of the described components.

The control unit (119) may include a merchant device interface component (586) arranged to interface with the merchant device (106) and to receive and transmit messages from and to the merchant device (106).

The control unit (119) may include an input and output component (588) arranged to interface with and optionally control modules of the storage compartment. For example, the input and output component (588) may interface with a motor for controlling opening and closing of a door of the storage compartment, a heating/cooling module for controlling the temperature of the storage compartment, one or more sensors for detecting events, such as the presence of an item and/or a body part in or proximate the storage compartment and the like. The input and output component (588) may be configured to output control signals to one or more modules of the storage compartment, for example to a motor to control opening of the storage compartment. The control unit (119) may for example be configured to monitor the storage compartment and associated components for errors and to notify the merchant device accordingly.

The control unit (119) may include a timing component (590) which may be arranged to interface with the input and output component (588) to control closing of the door once it has been opened.

FIG. 8 illustrates an example of a computing device (800) in which various aspects of the disclosure may be implemented. The computing device (800) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g. in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (830) may include a subscriber identity module (SIM) in the form of an integrated circuit that stores an international mobile subscriber identity and the related key used to identify and authenticate a subscriber using the computing device (800). One or more subscriber identity modules may be removable from or embedded in the computing device (800).

The external communications interface (830) may further include a contactless element (850), which is typically implemented in the form of a semiconductor chip (or other data storage element) with an associated wireless transfer element, such as an antenna. The contactless element (850) may be associated with (e.g., embedded within) the computing device (800) and data or control instructions transmitted via a cellular network may be applied to the contactless element (850) by means of a contactless element interface (not shown). The contactless element interface may function to permit the exchange of data and/or control instructions between computing device circuitry (and hence the cellular network) and the contactless element (850). The contactless element (850) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (800) and an interrogation device. Thus, the computing device (800) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient computer-readable medium, or may be provided via a signal or other transient means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display (845) or display adapter (840).

The computing device (800) may include a geographical location element (855) which is arranged to determine the geographical location of the computing device (800). The geographical location element (855) may for example be implemented by way of a global positioning system (GPS), or similar, receiver module. In some implementations the geographical location element (855) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (800). In some implementations, the geographical location element (855) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method conducted at a server computer and comprising:
receiving, from a consumer device, a location data message including a destination geographical location towards which a consumer associated with the consumer device is destined to travel;
identifying a merchant outlet physically located at a geographical location related to the destination geographical location;
receiving, from the consumer device, a selection of an item purveyed by the identified merchant outlet; and,
generating and transmitting, to a merchant device associated with the merchant outlet, an order request message including an indication of the selected item, the order request message ordering the selected item from the merchant outlet for collection by the consumer.

2. The method as claimed in claim 1, including providing, to the consumer device, a list of items purveyed by the identified merchant outlet, and wherein the item selection is a selection from the list of items.

3. The method as claimed in claim 1, wherein the location data message includes a current geographical location of the consumer device, wherein identifying the merchant outlet includes identifying a merchant outlet physically located at a geographical location related to the destination geographical location and the current geographical location, and wherein identifying the merchant outlet includes identifying a merchant outlet physically located at a geographical location falling within a predetermined range of a route between the current geographical location and destination geographical location.

4. The method as claimed in claim 1, wherein the item selection is associated with an amount and wherein the method includes processing a payment in respect of the amount against a financial account associated with the consumer in favor of a financial account associated with the merchant outlet.

5. The method as claimed in claim 1, including receiving, from the merchant device, a confirmation message confirming receipt of the order request message.

6. The method as claimed in claim 1, including maintaining merchant records relating to each merchant outlet, each merchant record including a geographical location and an operating status associated with the merchant outlet, wherein the merchant records are stored in a database and are updatable remotely by merchants.

7. The method as claimed in claim 6, including:
receiving, from the merchant device, a status indication message indicating a change in the operating status of the merchant outlet; and,
updating the merchant record to reflect the updated operating status.

8. The method as claimed in claim 1, including receiving, from the consumer device, an arrival indication message indicating the consumer's arrival at the merchant outlet.

9. The method as claimed in claim 8, wherein the arrival indication message is received in response to the consumer inputting an arrival indication into the consumer device at the time of arrival at the merchant outlet.

10. The method as claimed in claim 8, wherein the arrival indication message includes an updated current geographical location of the consumer device, and wherein the method includes comparing the updated current geographical location with the geographical location at which the merchant outlet is physically located so as to verify the consumer's arrival at the merchant outlet.

11. The method as claimed in claim 10, wherein, if the updated current geographical location of the consumer device falls outside of a predetermined range of the geographical location at which the merchant outlet is physically located, the method includes transmitting an arrival validation request message to the consumer device, the arrival validation request message prompting the consumer to validate arrival at the merchant outlet by performing an arrival validation operation.

12. The method as claimed in claim 1, including transmitting an item release instruction message configured to instruct a storage compartment physically located at the merchant outlet to open.

13. The method as claimed in claim 12, wherein the item release instruction message is transmitted to the merchant device, which is configured to use the item release instruction message to instruct opening of the storage compartment.

14. The method as claimed in claim 12, wherein the item release instruction message is transmitted to the consumer device, which is configured to use the item release instruction message to instruct opening of the storage compartment.

15. The method as claimed in claim 1, including providing, to the merchant device, a software application configured to execute on the merchant device and enable receiving and transmitting of messages from and to one or both of the server computer and a control unit associated with a storage compartment physically located at the merchant outlet.

16. The method as claimed in claim 1, including providing, to the consumer device, a software application configured to execute on the consumer device and enable receiving and transmitting of messages from and to the server computer.

17. A system including a server computer comprising:
a processor and a memory configured to provide computer program instructions to the processor to execute functions of components;
a location data message receiving component for receiving, from a consumer device, a location data message including a destination geographical location towards which a consumer associated with the consumer device is destined to travel;
an identifying component for identifying a merchant outlet physically located at a geographical location related to the destination geographical location;
an item selection receiving component for receiving, from the consumer device, a selection of an item purveyed by the identified merchant outlet; and,
an order request component for generating and transmitting, to a merchant device associated with the merchant outlet, an order request message including an indication of the selected item, the order request message ordering the selected item from the merchant outlet for collection by the consumer.

18. The system as claimed in claim 17, including the merchant device, comprising:
a processor and a memory configured to provide computer program instructions to the processor to execute functions of components;
a messaging component for receiving, from the server computer, the order request message including the indication of the selected item; and,
a control unit interface component for receiving and transmitting messages from and to a control unit of a storage compartment physically located at the merchant outlet.

19. The system as claimed in claim 18, including the control unit, comprising:
a processor and a memory configured to provide computer program instructions to the processor to execute functions of components;
a merchant device interface component for receiving and transmitting messages from and to the merchant device; and,
an input and output component for interfacing with modules of the storage compartment, including outputting a control signal to control opening of the storage compartment.

20. A computer program product comprising a computer-readable medium having stored computer-readable program code for performing the steps of:
receiving, from a consumer device, a location data message including a destination geographical location towards which a consumer associated with the consumer device is destined to travel;
identifying a merchant outlet physically located at a geographical location related to the destination geographical location;
receiving, from the consumer device, a selection of an item purveyed by the identified merchant outlet; and,
generating and transmitting, to a merchant device associated with the merchant outlet, an order request message including an indication of the selected item, the order request message ordering the selected item from the merchant outlet for collection by the consumer.
